(19) United States
(12) Patent Application Publication
(10) Pub. No.: US 2024/0162781 A1
(43) Pub. Date: May 16, 2024

(54) Magnet motor

(71) Applicant: Siarhei Shokhirau, Winter Park, FL (US)

(72) Inventor: Siarhei Shokhirau, Winter Park, FL (US)

(21) Appl. No.: 18/388,849

(22) Filed: Nov. 12, 2023

Related U.S. Application Data
(60) Provisional application No. 63/424,940, filed on Nov. 13, 2022.

(51) Int. Cl. H02K 7/00; H02K 7/075; H02K 7/11

(52) U.S. Cl. CPC H02K 7/003; H02K 7/075; H02K 7/11; H02K 1/17

(57) ABSTRACT

The mechanism transfers energy between mechanisms of reciprocating motions in planes perpendicular to each other. At the same time, this mechanism locks the mechanism of reciprocating motion in one of the planes during the movement of the unlocked mechanism of reciprocating motion in a plane perpendicular to it and vice versa. To achieve the best performance, the required distances between the magnets must be maintained, and the powers of the magnets must differ from each other. Also, the required configuration of the magnets must be to obtain an inversion of the attractive forces of magnets shaped like blocks with poles located under the steel blocks

### CROSS-REFERENCE TO RELATED PATENT

This application claims the benefit of U.S. Provisional Patent Application No. 63/424,940 filed on Nov. 13, 2022, entitled MAGNET MOTOR, the disclosure of which is hereby incorporated herein in its entirety by this reference

### FIELD OF INVENTION

The invention relates generally to motors and more specifically relates to motors driven by permanent magnets.

### BACKGROUND

The invention proposed by LaFonte group on video https://m.youtube.com/watch?v=YL3dzJ80hEM&pp=ygUOTGEgZm9udGUgbW90b3I%3D uses the following algorithm.
1. The magnets with parallel and opposite pole directions are attracted to each other by magnetic interaction forces. The steel blocks are attracted to the poles of the magnets.
2. Under the influence of the stored energy in the crankshaft, the magnets under the steel blocks move apart on the sides.
3. The steel blocks are torn away from the poles of the magnets.
4. The magnets are then attracted by the magnetic interaction forces, storing energy in the crankshaft.

The magnets shown in the video are supposedly cubic in shape.

The problem is this. In the position 3 the force required to tear off magnets that are moved away from each other is greater than the force of attraction of magnets attracted to each other, shown in position 1. The difference between these forces is approximately equal to the force of attraction of magnets to each other. Therefore, to compensate for these forces, it is necessary to supply energy from the outside. There are ways to reduce the negative difference in the forces of attraction to steel blocks. You can reduce the magnetic flux between magnets and steel blocks by separating the magnets under the steel blocks over a large distance. As far as we know, the relative magnetic permeability of steel is 700. Therefore, in order to reduce the magnetic flux to zero, it is necessary to move apart the magnets to a distance 700 times greater than the distance of the air gap, at which there is no magnetic interaction between the magnets. And this is a practically impossible task because moving magnets between steel blocks is a very energy-consuming process. Additionally, this method of moving the magnets apart has a limitation. For example, it is known that a magnet is attracted by its poles to two steel blocks due to the forces of the magnetic field. By attaching another steel block to the side of the steel blocks, as a result, a magnetic flux begins to flow through the magnet. In this case, the force required to separate the magnet from the steel blocks is 25% greater than in the absence of magnetic flux.

In the case where magnets with parallel and opposite pole directions are attracted to each other by magnetic interaction forces and are attracted by the poles to two steel blocks, at least 25% of the magnetic flux passes between the magnets and does not interact with the steel. Therefore, it is impossible to replenish this magnetic flux. In position 1, the two side sides of the magnets out of the 8 side sides of the magnets do not interact with the steel blocks with their magnetic lines. In position 3, one side of two magnets out of 8 side sides of magnets does not interact with the steel blocks with their magnetic lines. Therefore, the overall force of attraction of magnets to steel blocks will be 12.5% lower. This means that the functionality of this device is called into question.

In the case of using cylindrical magnets with axial magnetization as shown in the video https://m.youtube.com/watch?v=mbfqe2dyR3s

another problem arises.

The forces of magnetic interaction between such magnets are so small that they are of no interest for the practical implementation of a magnetic motor.

To solve these problems, a set of improvements is needed, which is as follows:
1. Select a configuration of magnets that will lead to an inversion of the negative difference in the forces of attraction of steel blocks in the extreme positions of moving magnets in positions 3 and 1 on the first video.
2. Supplement the device shown in the first video with another mechanism for moving steel blocks. This device must store the resulting energy from the difference in the forces of attraction and repulsion of steel blocks in positions 3 and 1 on the first video. The stored energy must be used in the subsequent operation of the entire mechanism.

The patent describes methods for inverting the force of attraction between steel blocks and block-shaped magnets depending on the distance between the magnets. These methods will allow you to significantly increase the power of the magnetic motor and also reduce weight due to the use of a flywheel of less weight and dimensions and, consequently, reduce friction in the mechanism components.

### BRIEF SUMMARY OF THE INVENTION

A device with mutually dependent systems of reciprocating movement of permanent magnets used as a working body and reciprocating movement of steel blocks used as magnetic flux conductors through a mechanism for transmitting mechanical energy. This mechanism transfers energy between two mechanisms of reciprocating motions in planes perpendicular to each other. At the same time, this mechanism locks the mechanism of reciprocating motion in one of the planes during the movement of the unlocked mechanism of reciprocating motion in a plane perpendicular to it and vice versa. This mechanism works together with a synchronization mechanism consisting of levers and rods.

### BRIEF DESCRIPTION OF THE DRAWINGS

FIG. 1 is a perspective view of an assembly drawing of the device.

FIG. 2 is a perspective view of an assembly drawing of the device.

FIG. 3 is a perspective view of an assembly drawing of the device.

FIG. 4 is a perspective view an assembly drawing of the device.

FIG. 5 is an exploded view of a carriage with frame.

FIG. 6 is an exploded view of a mechanism of magnetic fixation of the carriage in the extreme position.

FIG. 7 is an exploded view of a cheek of the traction mechanism.

FIG. 8 is an exploded view of a spring assembly.

FIG. 9 is an exploded view of a synchronization mechanism.

FIG. 10 is a perspective view of an assembly drawing of the main transmission mechanism.

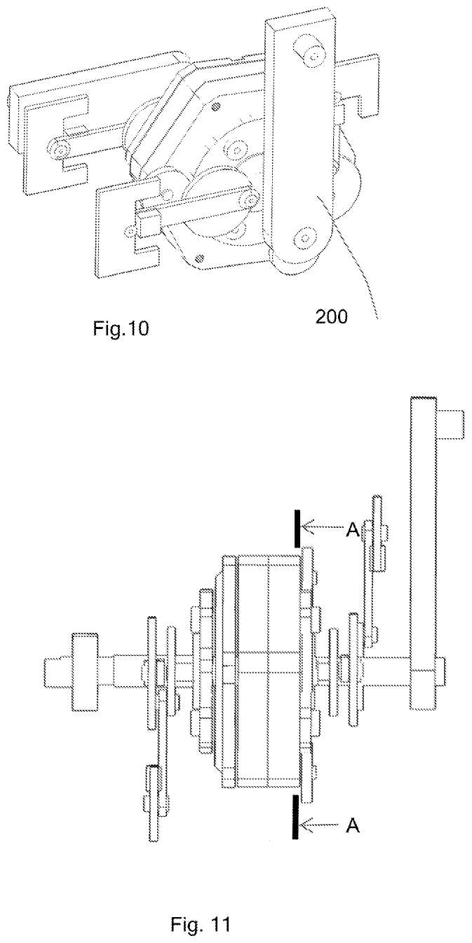

FIG. 11 is a side view of an assembly drawing of the main transmission mechanism.

FIG. 12 is an exploded view of a main transmission mechanism.

FIG. 13 is a perspective view of an assembly drawing of the auxiliary transmission mechanism.

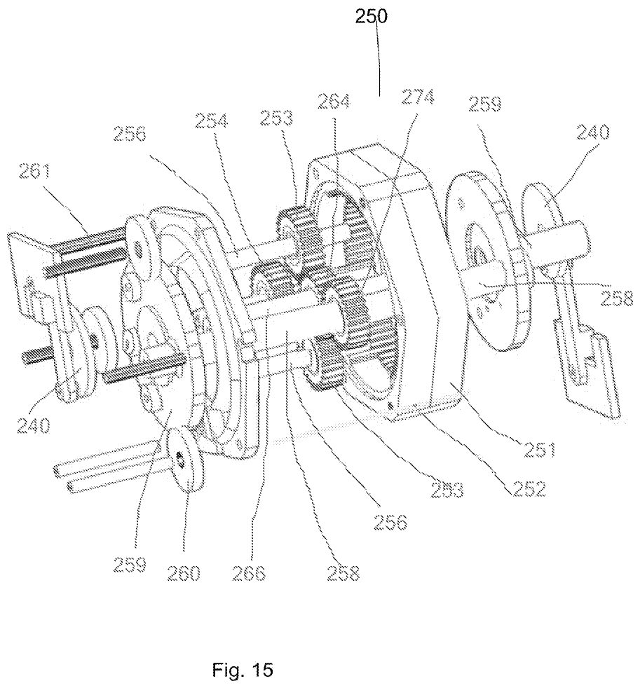

FIG. 14 is a side view of an assembly drawing of the auxiliary transmission mechanism.

FIG. 15 is an exploded view of an auxiliary transmission mechanism.

FIG. 16 is a perspective view of a power take-off mechanism.

FIG. 17 is an exploded view of a crankshaft with connecting rod and spring mechanism for fixing the position of the connecting rod.

FIG. 18 is exploded view of a carriage with installed two working and end magnets.

FIG. 19 is a perspective view of an assembly drawing of the carriage with installed two working and end magnets in a position where the distance E is maximal.

FIG. 20 is a perspective view of an assembly drawing of the carriage with installed two working and end magnets in a position where the distance E is minimal.

FIG. 21 is exploded view of a carriage with installed three working and end magnets.

FIG. 22 is a perspective view of an assembly drawing of the embodiment of the device.

FIG. 23 is a perspective view of an assembly drawing of the embodiment of the device.

FIG. 24 is a perspective view of an assembly drawing of the embodiment of the device.

FIG. 25 is a perspective view an assembly drawing of the embodiment of the device.

FIG. 26 is a perspective view of an assembly drawing of the embodiment of the device with parallel connection of traction mechanisms.

FIG. 27 is a perspective view of an assembly drawing of the embodiment of the device with serial connection of traction mechanisms.

FIG. 28 is a scheme describing the operation of the first embodiment of the device.

FIG. 29 is a scheme describing the operation of the second embodiment of the device.

### DETAILED DESCRIPTION OF THE INVENTION

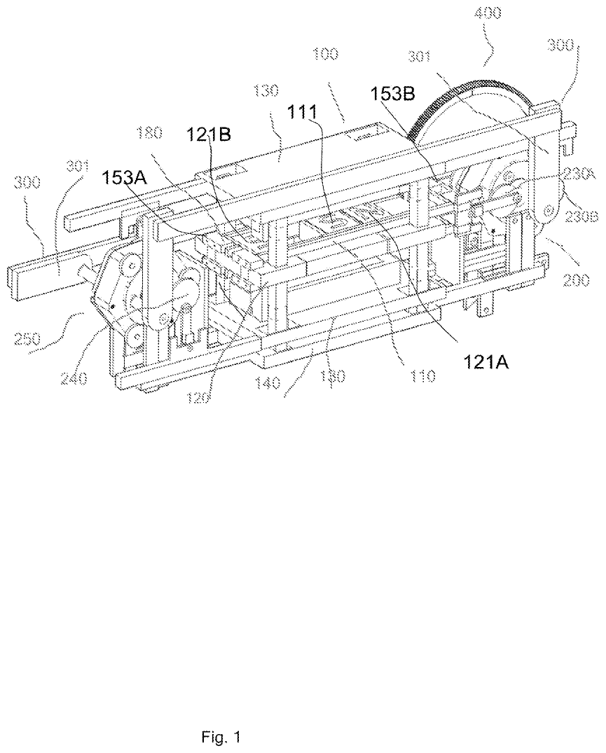

The device consists of five mechanisms shown in FIG. 1. Traction mechanism 100, transmission mechanisms 200, 250, synchronization mechanism 300 and power take-off mechanism 400.

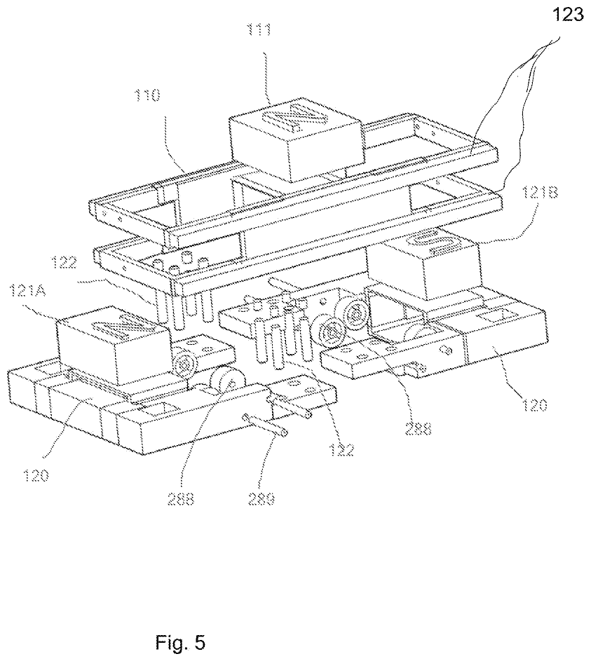

The traction mechanism 100 uses the attractive and repulsive force of the permanent magnets 111, 121A, 121B, shown in FIG. 5 to drive all the rotating and reciprocating elements of the other three mechanisms 200, 250, 300, 400, shown in FIG. 1.

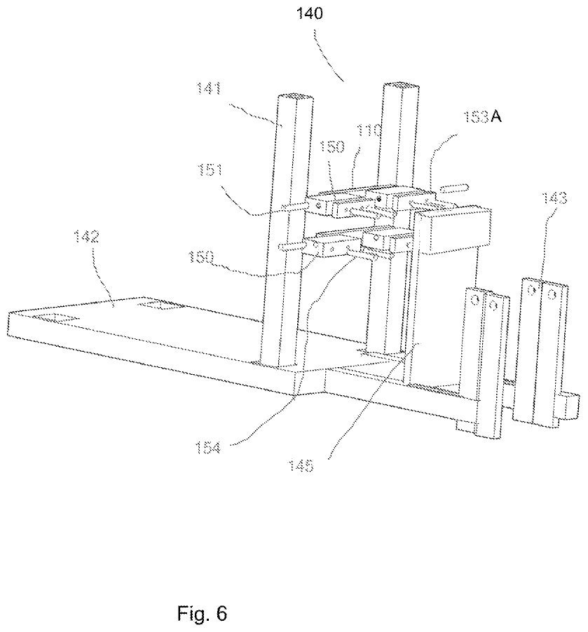

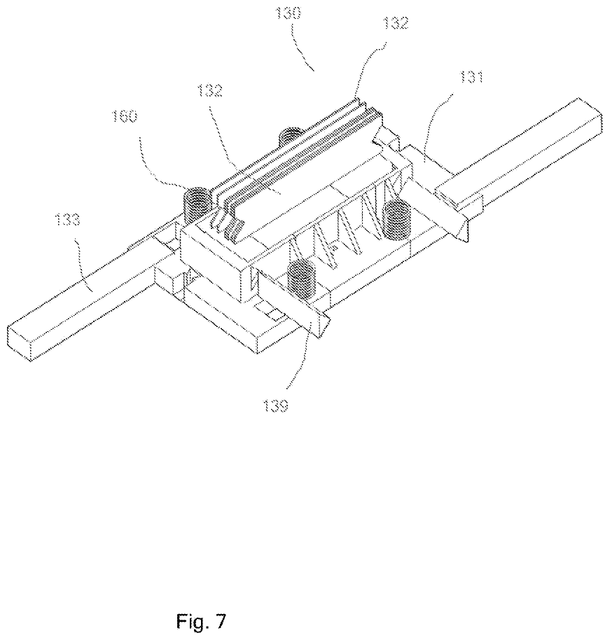

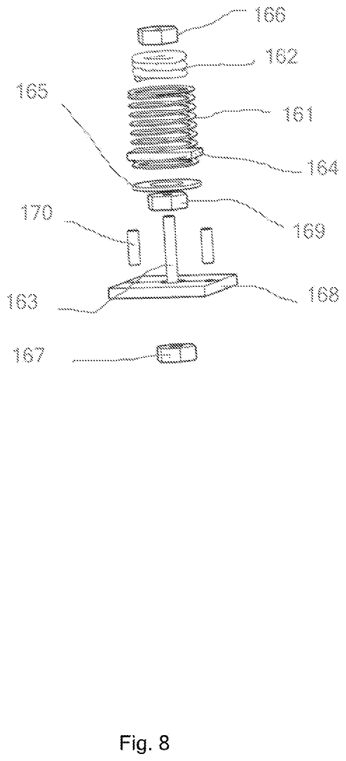

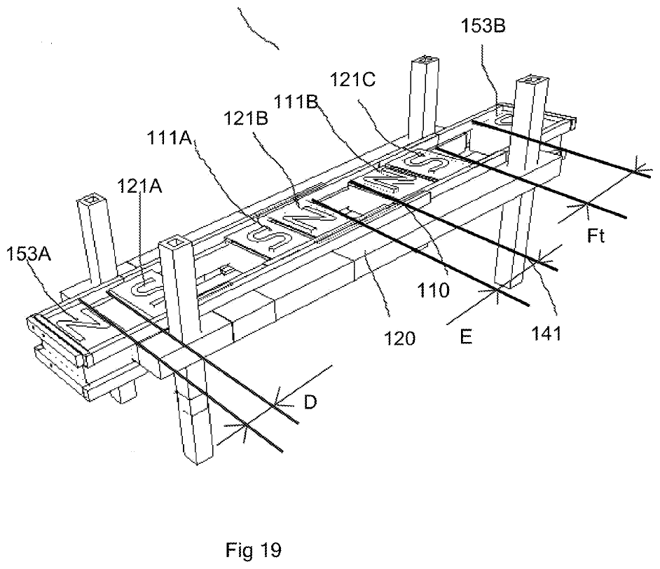

The traction mechanism 100 in FIG. 1 consists of a carriage 110 with a frame 120 with magnets 111, 121A, 121B, shown in FIG. 5, two cheeks 130, shown in FIG. 7, and a stand 140, shown in FIG. 6. Cheeks 130 in FIG. 7 consist of a base 131 in the form of a square frame with steel blocks 132 of cold-rolled iron plates fixed inside the frame 131 with plastic inserts 139. The thickness of the blocks 132 is not less than the thickness of the magnets 111, 121A, 121B installed in the carriage 110 in FIG. 5. Fasteners 231, shown in FIG. 17, of the transmission mechanisms 200, 250 in FIG. 1 are installed on the cheeks 130 through the fasteners 133 in FIG. 7. Also on cheeks 130 spring assemblies 160 are installed to compensate for the attractive forces of magnets 111, 121A, 121B, shown in FIG. 5, in steel blocks 132. Spring assemblies 160 in FIG. 8 consist of two springs 161 and 162 of different heights and stiffness fixed in the adjusting screws 163 by means of a nut 166 and 169 between the washers 164 and 165. The adjusting screws 163 are fixed on the base by means of two nuts 167 and 168. The nut 167 is used to clamp the adjusting screw 163. The nut 168 is used to be fixed by the screws 170 to the base 131 of the cheeks 130 in FIG. 7.

The base of the cheeks 131 with fasteners 133 made of non-metallic materials, such as all kinds of plastics, carbon fiber, fiberglass.

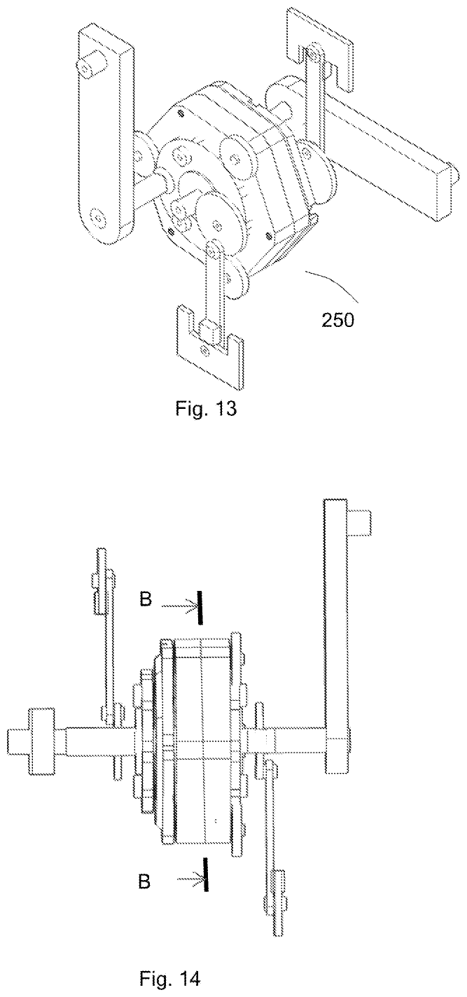

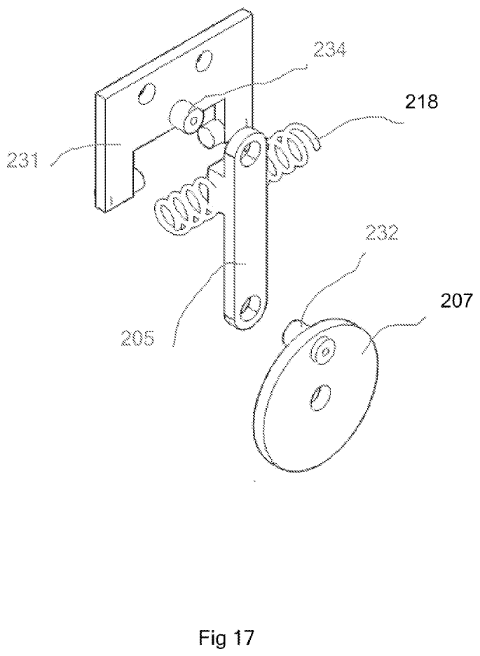

The carriage 110 with frame 120 consists of two elements in FIG. 5. Frames 120 and carriages 110. The carriage 110 with a frame 120 made of non-metallic materials, such as all kinds of plastics, carbon fiber, fiberglass. On the frame 120 are mounted magnets 121A and 121B with poles parallel to the plane of moving the carriage 110. This is for the case when the poles of magnets are considered as halves of magnets. If we describe using a vector the direction from the north pole of the magnet to the south, then in this the magnets 121A and 121B have the vector of the poles are perpendicular to the plane of moving the carriage 110. The poles of the magnets in the frame 121A and 121B in FIG. 5 are reversed relative to each other and the vectors of the poles of the magnets 121A and 121B are reversed relative to each other. On the carriage 110 installed the eight bearings or rollers 288 on axis 289 to hold the carriage 110. On the carriage 110 is mounted a magnet 111 with the poles parallel to the plane of moving the carriage 110. The magnet 111 have the vector of the poles are perpendicular to the plane of moving the carriage 110. In FIG. 5 the carriage 110 moves toward and away from the main shafts 208, 258 of the transmission mechanism 200, 250, shown in FIG. 12, FIG. 15 respectively.

In the FIG. 17 a fasteners 231 for connecting rods 205 of the crank mechanisms 230A, shown in FIG. 1, 6, are installed on the carriage 110, which are fastened with a screw 151 to the assembly unit 150.

The carriage 110 is additionally attached to the assembly unit 150 with screws 154 and the permanent magnet 153A, 153B with screws 154. Magnets 153A, 153B must be of sufficient power to hold the moving part of the carriage 110 in its extreme positions and must be at least more powerful than the magnets installed on the moving part of the carriage 110. Also, the magnets 153A, 153B have the ability to select the pole direction by selecting the mounting side on the assembly to balance the magnets 121A, 121B. The poles selection should be done as follows. For the case where magnet 121A is more powerful than magnet 121B, the following setting is used. The magnet 153A is installed with a poles direction perpendicular to the plane of movement of the movable part of the carriage 110 and opposite to the poles direction of the magnet 121A. The magnet 153B is installed with a poles direction perpendicular to the plane of movement of the movable part of the carriage 110 and coincides to the pole direction of the magnet 121B.

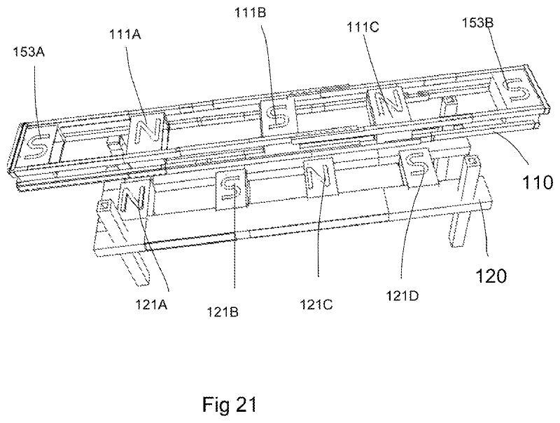

For the case where the power of magnet 121A is equal to or less than the power of magnet 121B, the following setting is used. Magnets 153A and 153B are installed with the poles direction parallel to the plane of movement of the movable part of the carriage 110. Also, in order to configure the device for maximum output power, it is possible to adjust the distance to the assembly unit by unscrewing screw 154. The distance D between the counter 121A and compensating 153A magnet must be maintained in the state of the moving part of the carriage 110 when the distance E is maximum shown in FIG. 19. The distance D is equal to at least the length of the counter magnet 121A when measured in the direction of the moving part of the carriage 110. In FIG. 1 the cheeks 130 reciprocate in a plane perpendicular to the reciprocating plane of the carriage 110.

Stand 140 in FIG. 1, 6 consists of four racks 141, bottom frame 142 with fasteners 143 for the transmission mechanism 200, 250, shown in FIG. 1. In FIG. 6 the bottom frame 142, fasteners 143, racks 141 can be made of metal, as well as various plastics, fiber fiberglass. To fasteners 143, a flexible steel plate 145 is inserted into the notches, which is used in the mechanism for fixing the carriage 110 in one of the extreme positions and corresponding to the positions of the upper and lower dead points of the crankshaft 230A shown in FIG. 1.

The transmission mechanism 200, shown in FIG. 1, 10, 11, 12 is used to transfer power from the horizontal reciprocating mechanism to the vertical reciprocating mechanism and vice versa. At the same time, this mechanism blocks the reciprocating movement mechanism in the horizontal plane while the unlocked reciprocating movement mechanism moves in the vertical plane, and then this mechanism blocks the reciprocating movement mechanism in the vertical plane while the unlocked reciprocating movement mechanism moves in the horizontal plane.

The main transmission mechanism 200 in FIG. 12 is composed of an internal gear 201 with a internal full set of teeth, an internal gear with internal partial set of teeth 202, six spur gears 203, 204A, 204B, 214, four auxiliary shafts 206, two cranks 230A, two cranks 230B, a main shaft 208, gear housing 209 consisting of two halves, three support rollers 210, six tie bolts 211, cap 212. Spur gears 203 are located on three auxiliary shafts 206 and a central gear 214 on the main shaft 208. Gear 214 on the main shaft 208 is fixed. All four gears 203, 214 interact only with the internal gear 201 with a internal full set of teeth. The internal spur gear 201 is aligned with the internal partial set of teeth gear 202. The two remaining spur gears 204 A, 204B are located on and fixed to the auxiliary shafts 206 and interact only with the internal partial set of teeth gear 202. All main and auxiliary shafts 208, 206 are located in the crankcase 209 on bearings or bushings. The crankcase is bolted to fasteners 143 shown in FIG. 6. At the ends of the auxiliary shafts 206 protruding outside the crankcase 209, cranks 230A, 230B. The cranks 230A, 230B in FIG. 17 is composed of the crankshafts 207 with connecting rods 205 mounted on bearings or bushings in notches in the connecting rods 205 are fixed. All connecting rods 205 are attached to the fixtures 231 on the bushings sitting on axis 234 and are centered by springs 218 in the upper or lower dead centeruuuuus in a position parallel to the planes of reciprocating movements. Support rollers 220 in FIG. 12 are mounted on three of the six pinch bolts 211 on bushings or bearings.

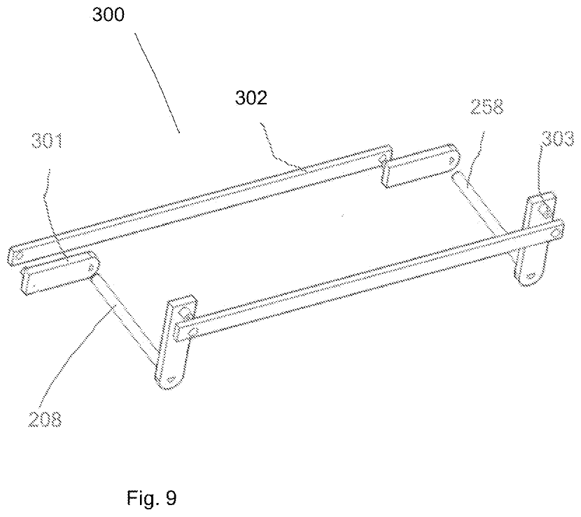

In the case when the auxiliary transmission mechanism 250 in FIG. 1 is used in the device, then the synchronization mechanism 300 is used, which is installed on the main shafts 208, 258 shown in FIG. 9.

The auxiliary transmission mechanism 250 in FIG. 1, 13, 14, 15 is shown in FIG. 15, 17 consists of a gear with a internal full set of teeth 251, a gear with a internal partial set of teeth 252, five spur gears 253, 254, 264, 274 four auxiliary shafts 256, 266, two crankshafts 207, two connecting rods 205, a main shaft 258, gear housing 259 consisting of two halves, three support rollers 260, six pinch bolts 261. Spur gears 253, 274 are located on three shafts 256, 258 respectively and the central 264 on the auxiliary shaft 266. The gear 274 on the main shaft 258 is fixed. The gear 254 on the auxiliary shaft 256 is fixed. All four gears 253, 264 interact only with the internal gear 251 with a internal full set of teeth. The 251 internal gear with full set of teeth is aligned with the internal gear 252 with partial set of teeth. The 254 spur gear interacts only with the 252 internal gear with partial set of teeth. The crankcase is bolted to fasteners 143 shown in FIG. 6. At the ends protruding outside the crankcase 259 of the auxiliary shaft 256, cranks 240. The cranks 240 in FIG. 17 is composed of the crankshafts 207 with connecting rods 205 installed on bearings or bushings. The bearings are fixed in notches in the connecting rods 205. All connecting rods 205 are attached to the fixtures 231 on the bushings sitting on axis 234 and are centered by springs 218 in dead center in a position parallel to the planes of reciprocating movements. All fasteners 231 are bolted to fasteners 133, shown in FIG. 7. Support rollers 260 in FIG. 15 are mounted on three of the six pinch bolts 261 on bushings or bearings.

The synchronization mechanism 300 in FIG. 9 consists of the levers 301 and rods 302. The levers 301 installed on one side of the main shafts 208, 258 of the transmission mechanisms 200, 250 shown in FIG. 1 are offset by 90 degrees relative to the levers 301 installed on the other side of the main shafts 208, 258. The levers 301 of the main transmission mechanism 200 in FIG. 1 are parallel to the levers 301 of the auxiliary transmission mechanism 250. The levers 301 in FIG. 9 on opposite sides of the main shafts 208, 258 of the main 200 and auxiliary 258 transmission mechanisms at the ends are connected by rods 302 on bearings or bushings located on the axis 303 and which are inserted into the notches in the rods 302.

All parts of the synchronization mechanism except for axis 303 can be made of metal, as well as various plastics, carbon fiber fiberglass. Axis 303 of metals.

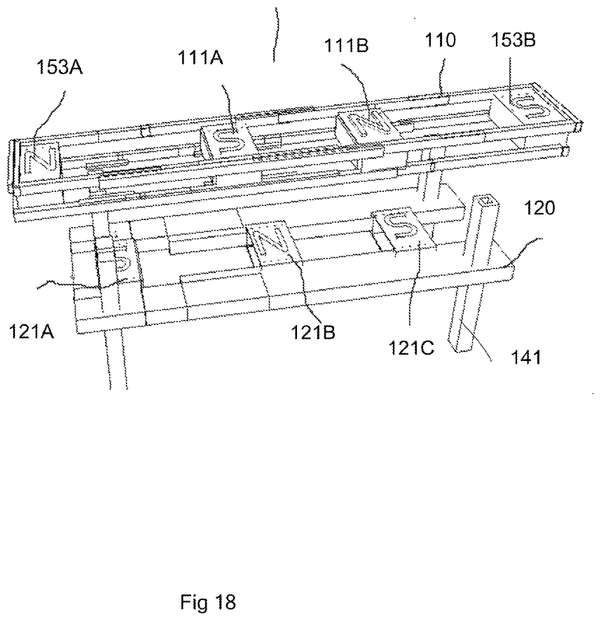

The power take-off mechanism 400 in FIG. 1 consists of a large gear 401 shown in FIG. 16 fixed on the main shaft 208 shown in FIG. 1, 12 between the transmission mechanism 200 and the lever 301. In FIG. 16 the base 403 with the bearing or bushing is fixed to the bracket 407 by the bolts 405.

The spur gear 410 is fixed on the shaft 404. One of the end of the shaft 404 is inserted into the base 403 on bearing or bushing. On the opposite side of the shaft 404 on the shaft fixed clutch 406 for mounting the shaft of the geared generator with flywheel 409. The geared generator with flywheel 409 was screwed to the bracket 407 with two bolts 408.

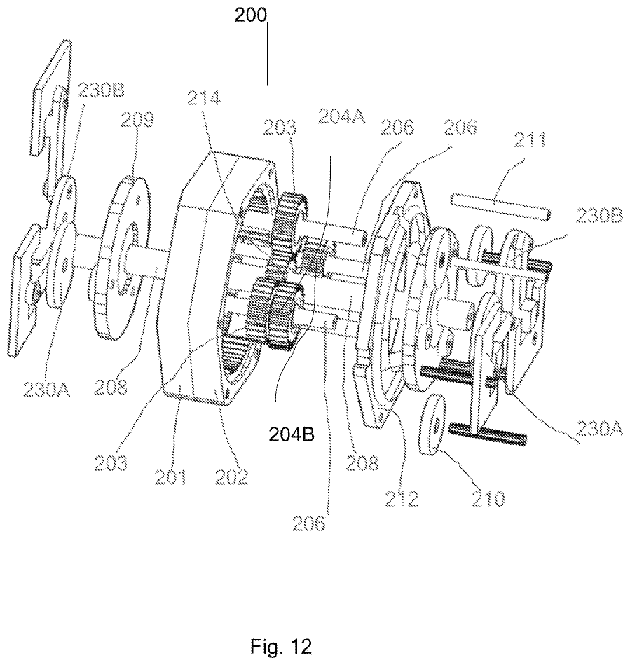

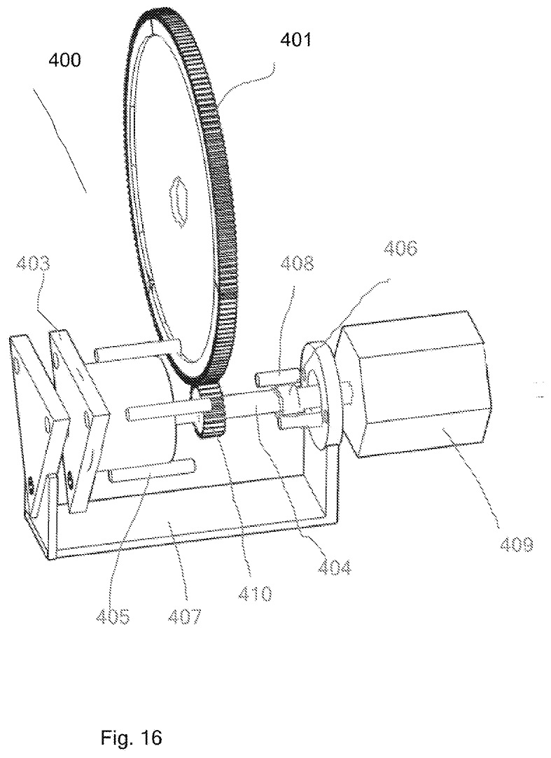

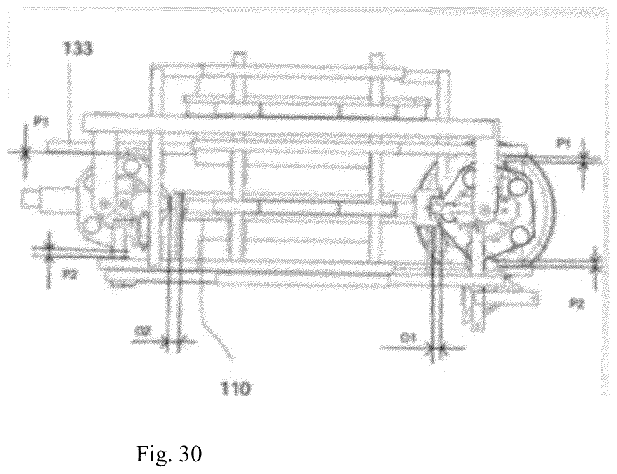

Let us take as the reference point of the rotation of the gears 202, 252 in FIG. 12, 15, 28 the reference point of the rotation M, which is located at the top in the center. In FIG. 12, 28 for gear 204A, rotation reference point I is located on shaft 208. For gears 204B, 254 in FIG. 12, 15, 28 rotation reference points K are located on shafts 208, 258, respectively. On FIG. 28 shows sections A-A and B-B, which correspond to the sections in the places indicated in FIG. 11, FIG. 14 respectively.

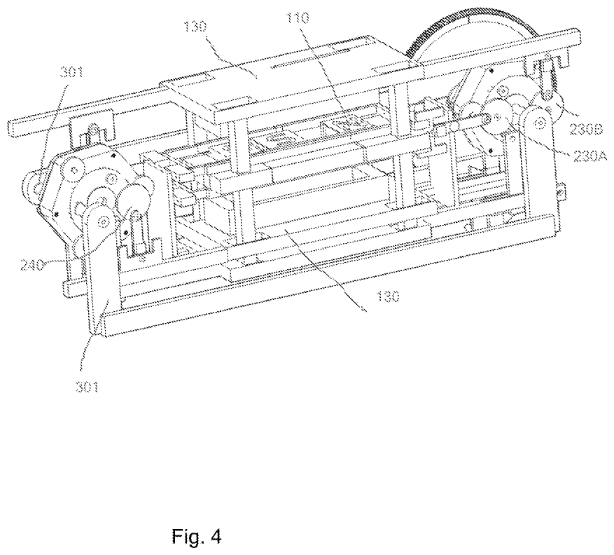

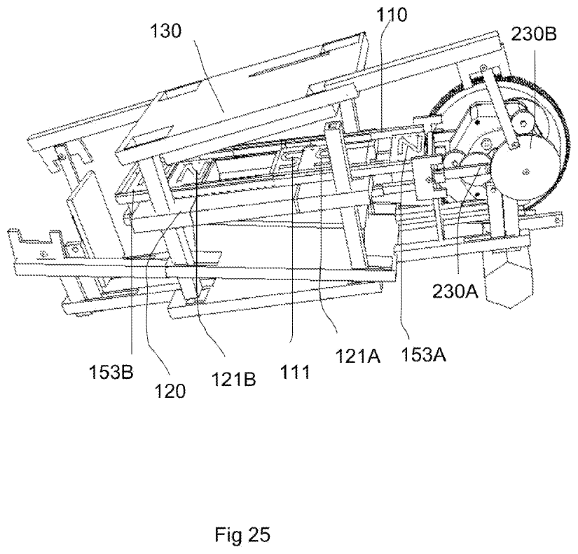

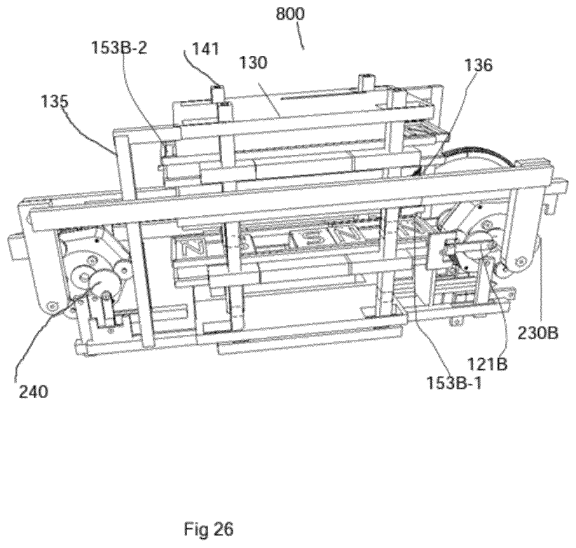

At the moment 2 in FIG. 28 when M in M2, K in K2, I in I2 and at the moment shown in FIG. 4 when the crank mechanisms 230A are at the top dead center, and the crank mechanisms 230B, 240 are at the top dead center, also the cheeks 130 are located at an equal distance from the carriage 110 with the frame 120 at a distance exceeding the thickness of the magnets 111, 121A, 121B, shown in FIG. 5, so that at this moment the carriage 110 moves from the static magnet 121A with coinciding poles of the magnet 111 to the magnet with opposite poles 121B. In this case, the main transmission mechanism 200 in FIG. 12 starts to rotate the internal gear 202 using the gear 204A fixed to the auxiliary shaft 206, which is driven clockwise by the crank mechanisms 230A. At the same time, the crank mechanisms 230B, 240 fixed on the shafts 206, 256 continue to be in the upper dead centers fixed by the springs 218 in FIG. 17, and the gears 204B, 254 fixed to the shafts 206, 256 fall into the gap of the internal gear 202, 252, in FIG. 12, FIG. 15 respectively, and do not rotate. Further rotation is transmitted from the internal gear 202 in FIG. 12 to the internal gear 201 which rotates the gear 214 through the gear 203. Since the gears 214, 274 are fixed to the main shafts 208, 258, shown in FIG. 12, FIG. 15 respectively, the rotation is transmitted from the gear 214 shown in FIG. 12 to the gear 274 shown in FIG. 15 using the synchronization mechanism 300, shown in FIG. 9, and also to the gear 404 of the power take-off mechanism 400, shown in FIG. 16, through the gear 401 fixed to the main shaft 208, shown in FIG. 12. The movement of the carriage 110 shown in FIG. 1 continues until the teeth of the gear 202, 252 go into a gap at the point of interaction with the gear 204B, 254, which corresponds to position 3 in FIG. 28 when M is in M3, K is in K2, I is in I1. Thus, there is transition of M from M2 to M3, I from 12 to I1 which is shown in the diagram in FIG. 28 and externally depicted in FIG. 1. The levers 301 together with the main shafts 208, 258, are rotated 180 degrees counterclockwise. When the carriage 110 completes the movement, in FIG. 1, 6 the permanent magnets 153B attracted to the flexible plate 145. For the case when magnet 121A is more powerful than magnet 121B, distance D between magnet 153A and magnet 121A must be adjusted using screw 154 so that distance D is greater than distance Ft shown in FIG. 23-24. Also, magnet 153A using screw 154 must be adjusted so that both steel blocks 132 completely overlap the poles of magnet 153A on both sides, and the poles of magnet 153B should not be overlapped by steel blocks 132. When the distance E is maximum, the poles of compensating magnet 153A must be completely closed by steel blocks 132, while the auxiliary magnet 153B must be separated from the steel blocks 132 by at least a distance A, and when the distance E is minimum, the poles of auxiliary magnet 153B must be completely closed by steel blocks 132, and at the same time, the compensating magnet 153A must be spaced from steel blocks 132 at least a distance of C.

The distance A is equal to the distance C and equal to at least the halve of the length of the compensating magnet 153A when measured in the direction of the moving part of the carriage 110.

The spring 218 shown in FIG. 17 centering the connecting rod 205 are used to position of the top dead center of the crankshaft 230A and the fixing the carriage 110 shown in FIG. 1 in the extreme position.

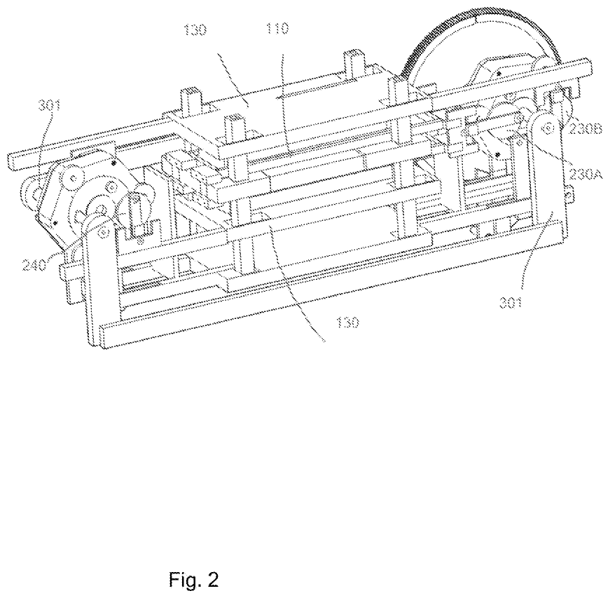

Further, under the action of the force of attraction of the cheeks 130 to the magnets 111, 112A, 112B, shown in FIG. 5, the cheeks 130 move, which leads to the rotation of the crank mechanisms 230B, 240 from the top dead center to the bottom dead center shown in FIG. 2. It starts to rotate the internal gears 202, 252 using the gears 204B, 254 fixed to the auxiliary shafts 206, 256, which is driven clockwise by the crank mechanisms 230B, 240 in FIG. 12, FIG. 15 respectively. Next, the rotation is transmitted from the internal gears 202, 252 to the internal gears 201, 251, which rotate the gears 214, 264, through the gears 203, 253 respectively. Since the gears 214, 274 are fixed to the main shafts 208, 258, respectively, the rotation is transmitted from the gear 214, shown in FIG. 12 to the gear 264, shown in FIG. 15 using the synchronization mechanism 300 in FIG. 2 and also to the gear 404 of the power take-off mechanism 400 through the gear 401 fixed to the main shaft 208 in FIG. 2, 9, 16. The movement of the cheeks 130 continues until the teeth of the gear 202, 252 move into the gap at the point of interaction with the gear 204B, 254, in FIG. 12, FIG. 15 respectively, which corresponds to position 4 in FIG. 28 when M is in M4, K is in K1, I is in I1. Thus, there is a transition of M from M3 to M4, K from K2 to K1, which is shown in the diagram in FIG. 28 and in FIG. 2 where the crank mechanisms 230A are at the bottom dead center, the crank mechanisms 230B, 240 are at the bottom dead center. The levers 301 together with the shafts 208, 258, shown in FIG. 12, FIG. 15 respectively, are rotated 180 degrees counterclockwise.

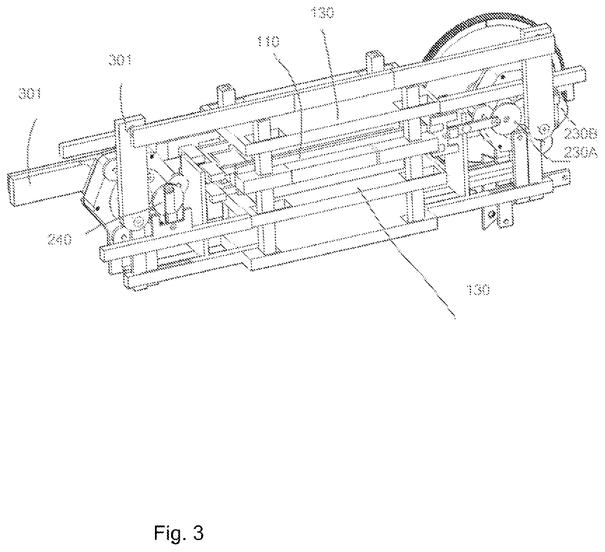

At the moment shown in FIG. 3 when the cheeks 130 are attracted and pressed by the magnetic field close to the carriage 110 with the frame 120, the magnet 111 shown in FIG. 5 moves under the action of the stored energy on the flywheel of the generator 409 through the gears 404, 401, shown in FIGS. 16 and 214, 203, 201, 202, 204A through the rotation of the crank mechanisms 230A, shown in FIG. 12, moves from static magnet 121B with opposite poles to magnet 121A with matching poles shown in FIG. 5. In this case, the crank mechanisms 230B, 240 fixed on the shafts 206, 256, respectively, continue to be in the lower dead centers fixed by the springs 218 shown in FIG. 17, and the gears 204B, 254 fixed to the shafts 206, 256, respectively, fall into the gap of the internal gears 202, 252 in FIG. 12, FIG. 15, respectively and do not rotate. The movement of the carriage 110 in FIG. 3 continues until the teeth of the gear 202 move into the gap at the point of interaction with the gear 204A, which corresponds to position 1 in FIG. 28 when M is in M5, K is in K1, I is in I2. Thus, there is a transition of M from M4 to M5, I c I1 to I2 which is shown in the diagram in FIG. 28 and in FIG. 3 where the crank mechanisms 230A are at the top dead center, and the crank mechanisms 230B, 240 are at the bottom dead center. The levers 301 together with the shafts 208, 258, shown in FIG. 12, FIG. 15 respectively, are rotated 180 degrees counterclockwise. When the carriage completes its movement, looking at the FIG. 6 the permanent magnets 153B attracted to the plate 145 in this case, the distance Ft between the magnet 153B and the magnet 121B must be adjusted using the screw 154 so that the distance Ft is less than the distance D and the poles of the magnet 153B must be completely covered on both sides by the steel plates 132. The spring 218 shown in fug. 17 centering the connecting rod 205 are used to fix the carriage 110 in the extreme position and top dead center of the crankshaft 230A.

Let's consider a complex of forces F that includes the elastic force of springs F(0), the difference force F(d) which in turn consists of the difference between the forces F(1) and F(4). F(4) is the force of attraction of steel blocks to magnets in position 4 in FIG. 28. Accordingly F(1) is the force of attraction of steel blocks to magnets in position 1 in FIG. 28.

Further, under the influence of a complex of forces F the crank mechanisms 230B, 240, shown in FIG. 4 clockwise rotate from top dead center to bottom dead center and cheeks 130 move. On the FIG. 4 the movement of the cheeks 130 continues until the teeth of the gear 202, 252 move into the gap at the point of interaction with the gear 204B, 254, which corresponds to position 2 in FIG. 28 when M is in M0, K is in K2, I is in I2. Thus, there is a transition of M from M5 to M0, K from K1 to K2, which is shown in the diagram in FIG. 28 and in FIG. 4 where the crank mechanisms 230A are at top dead center, and the crank mechanisms 230B, 240 are at top dead center. The levers 301 together with the shafts 208, 258, shown in FIG. 12, FIG. 15 respectively, are rotated 180 degrees counterclockwise.

Then the whole movement is repeated.

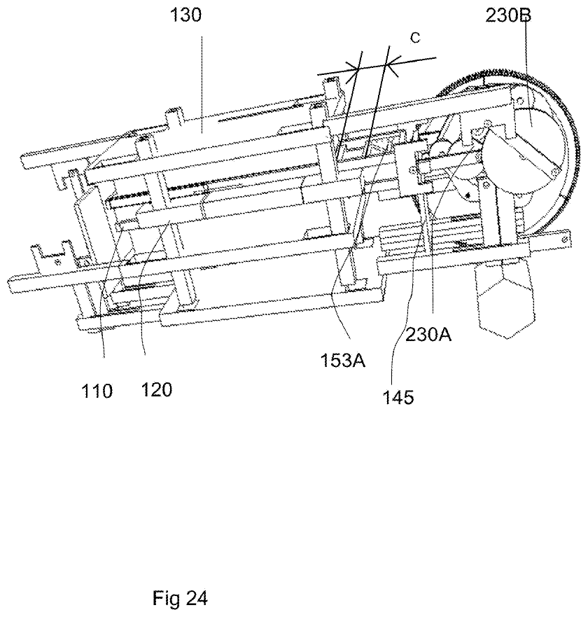

The device 700 in the FIG. 22 consists of traction mechanism 100, transmission mechanism 200 and power take-off mechanism 400.

The traction mechanism 100 uses the attractive and repulsive force of the permanent magnets 111, 121A, 121B, 153B to drive all the rotating and reciprocating elements of the other two mechanisms 200, 400.

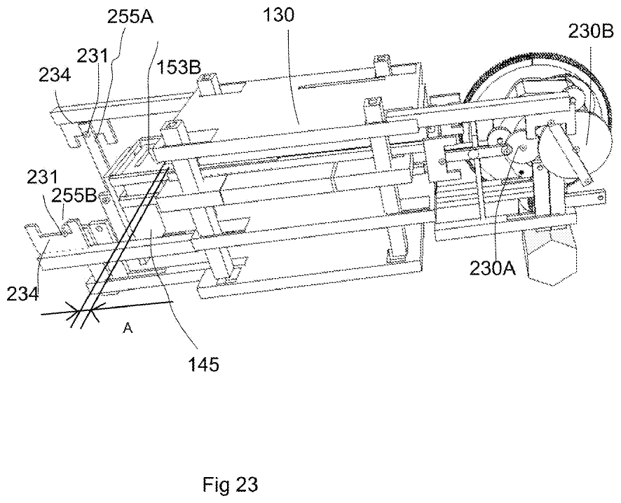

The traction mechanism 100 consists of a carriage 110 with a frame 120 with magnets 111, 121A, 121B, two cheeks 130, shown in FIG. 7, and a stand 140, shown in FIG. 6. Cheeks 130 in FIG. 7 consist of a base 131 in the form of a square frame with steel blocks 132 of cold-rolled iron plates fixed inside the frame 131 with plastic inserts 139. The thickness of the blocks 132 is not less than the thickness of the magnets 111, 121A, 121B, 153A, 153B installed in the carriage 110 in FIG. 21. Fasteners 231, shown in FIG. 17, of the transmission mechanism 200 in FIG. 21 are installed on the cheeks 130 through the fasteners 133 in FIG. 7. In FIG. 23 connecting rods 255A, 255B are bolted on one side to fasteners 143B. The connecting rods 255A, 255B are attached to the fixtures 231 on the bushings sitting on the axis 234 shown in FIG. 22.

The power take-off mechanism 400 in FIG. 21 consists of a large gear 401 shown in FIG. 16 fixed on the main shaft 208 shown in FIG. 12.

The small gear 410 is fixed on the shaft 404. One of the end of the shaft 404 is inserted into the base bearing of bushing 403. On the opposite side of the shaft 404 on the shaft fixed clutch 406 for mounting the shaft of the geared generator with flywheel 409. The geared generator with flywheel 409 was screwed to the bracket 407 with two bolts 408.

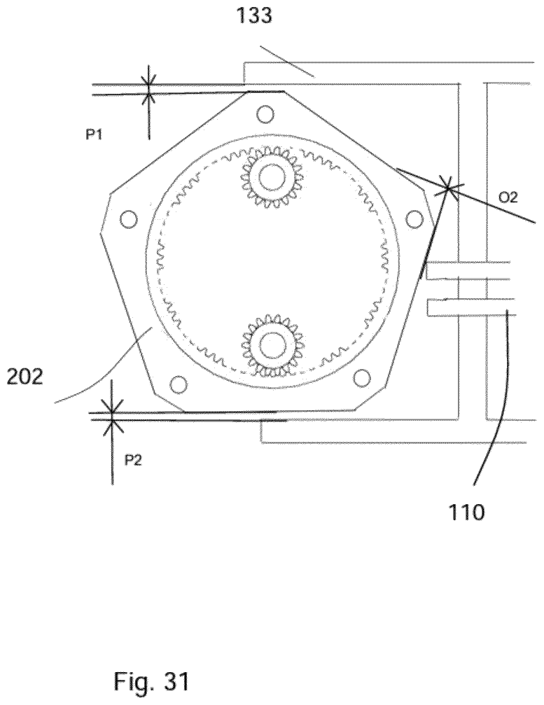

Let us take as the reference point of the rotation of the gear 202 in FIG. 12, the reference point of the rotation M, which is located at the top in the center. In FIG. 12 for gear 204A, rotation reference point I is located on shaft 208. For the gear 204B in FIG. 12, rotation reference points K are located on shafts 208, On FIG. 29 shows section A-A, which correspond to the sections in the places indicated in FIG. 11.

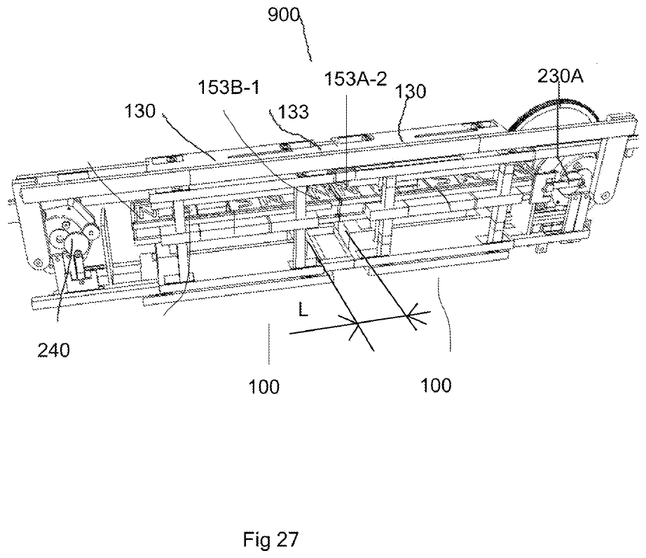

At the moment 2 in FIG. 29 when M in M2, K in K2, I in I1 and at the moment shown in FIG. 25 when the crank mechanisms 230A are at the bottom dead center, and the crank mechanism 230B are at the top dead center, also the cheeks 130 are located at an equal distance from the carriage 110 with the frame 120 at a distance exceeding the thickness of the magnets 111, 121A, 121B, shown in FIG. 25, so that at this moment the carriage 110 moves from the static magnet 121A with coinciding poles of the magnet 111A to the magnet with opposite poles 121B. In this case, the main transmission mechanism 200 in FIG. 12 starts to rotate the internal gear 202 using the gear 204A fixed to the auxiliary shaft 206, which is driven clockwise by the crank mechanisms 230A. At the same time, the crank mechanism 230B fixed on the shaft 206 continue to be in the upper dead centers fixed by the springs 218 in FIG. 17, and the gear 204B fixed to the shaft 206 fall into the gap of the internal gear 202, in FIG. 12, and do not rotate. Further rotation is transmitted from the internal gear 202 in FIG. 12 to the internal gear 201 which rotates the gear 214 through the gear 203. Since the gear 214 are fixed to the main shaft 208 shown in FIG. 12, the rotation is transmitted from the gear 214 to the gear 404 of the power take-off mechanism 400, shown in FIG. 16, through the gear 401 fixed to the main shaft 208, shown in FIG. 12. The movement of the carriage 110 shown in FIG. 25 continues until the teeth of the gear 202 go into a gap at the point of interaction with the gear 204B, which corresponds to position 3 in FIG. 29 when M is in M3, K is in K2, I is in I2. Thus, there is transition of M from M2 to M3, I from I1 to I2 which is shown in the diagram in FIG. 29 and externally depicted in FIG. 22. When the carriage 110 completes the movement, in FIG. 22 the permanent magnets 153B attracted to the flexible plate 145 in FIG. 6, 22. Moreover, for the case when magnet 121A is more powerful than magnet 121B, distance D between magnet 153A and magnet 121A must be adjusted using screw 154 so that distance D is greater than distance Ft. Also, magnet 153A using screw 154 must be adjusted so such that both steel blocks 132 completely overlap the poles of magnet 153A on both sides and the poles of magnet 153B should not be overlapped by steel blocks 132. The spring 218 shown in FIG. 17 centering the connecting rod 205 are used to position of the top dead center of the crankshaft 230A and the fixing the carriage 110 shown in FIG. 22 in the extreme position.

Further, under the action of the force of attraction of the cheeks 130 to the magnets 111, 121A, 121B, shown in FIG. 22, the cheeks 130 move, which leads to the rotation of the crank mechanisms 230B, 240 from the top dead center to the bottom dead center shown in FIG. 23. It starts to rotate the internal gear 202 using the gear 204B fixed to the auxiliary shaft 206 which is driven clockwise by the crank mechanism 230B in FIG. 12. Next, the rotation is transmitted from the internal gear 202 to the internal gear 201, which rotate the gear 214, through the gear 203. Since the gear 214 are fixed to the main shaft 208, the rotation is transmitted from the gear 214, shown in FIG. 12 to the gear 404 of the power take-off mechanism 400 through the gear 401 fixed to the main shaft 208 in FIG. 9. The movement of the cheeks 130 continues until the teeth of the gear 202 move into the gap at the point of interaction with the gear 204B in FIG. 12, which corresponds to position 4 in FIG. 29 when M is in M4, K is in K1, I is in I2. Thus, there is a transition of M from M3 to M4, K from K2 to K1, which is shown in the diagram in FIG. 29 and in FIG. 23 where the crank mechanisms 230A are at the top dead center and the crank mechanism 230B are at the bottom dead center.

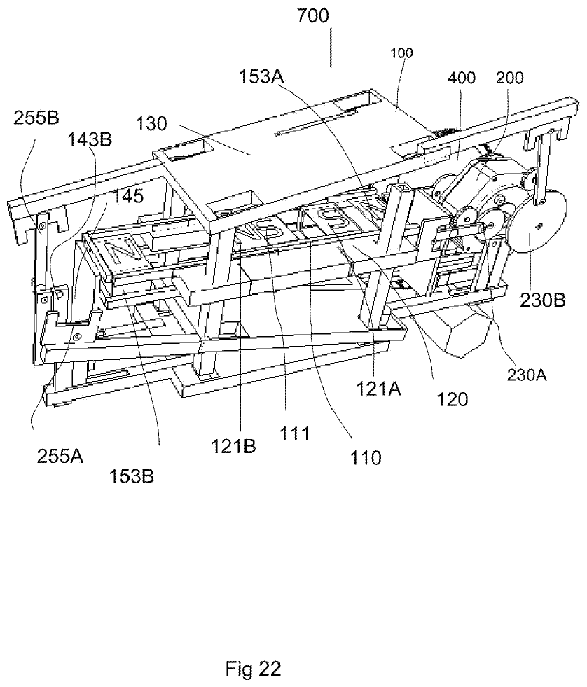

At the moment shown in FIG. 23 when the cheeks 130 are attracted and pressed by the magnetic field close to the carriage 110 with the frame 120, the magnet 111 shown in FIG. 19, 20 moves under the action of the stored energy on the flywheel of the generator 409 through the gears 404, 401, shown in FIGS. 16 and 214, 203, 201, 202, 204A through the rotation of the crank mechanisms 230A, shown in FIG. 12, 23, moves from static magnet 121B with opposite poles to magnet 121A with matching poles shown in FIG. 19, 20. In this case, the crank mechanism 230B fixed on the shafts 206, continue to be in the lower dead centers fixed by the springs 218 shown in FIG. 17, and the gear 204B fixed to the shaft 206, fall into the gap of the internal gear 202 in FIG. 12 and do not rotate. The movement of the carriage 110 in FIG. 23 continues until the teeth of the gear 202 move into the gap at the point of interaction with the gear 204A, which corresponds to position 1 in FIG. 28 when M is in M5, K is in K1, I is in I1. Thus, there is a transition of M from M4 to M5, I from I2 to I1 which is shown in the diagram in FIG. 29 and in FIG. 24 where the crank mechanisms 230A are at the bottom dead center, and the crank mechanism 230B are at the bottom dead center. When the carriage completes its movement, looking at the FIG. 6 the permanent magnets 153B attracted to the plate 145 in this case, the distance Ft between the magnet 153B and the magnet 121B should be such that the distance Ft is less than the distance D as shown in FIG. 20 and the poles of magnet 153B must be completely covered on both sides by steel blocks 132, as shown in FIG. 24. The spring 218 shown in fug. 17 centering the connecting rod 205 are used to fix the carriage 110 in the extreme position and top dead center of the crankshaft 230A.

Let's consider a complex of forces F that includes the elastic force of springs F(0), the difference force F(d) which in turn consists of the difference between the forces F(1) and F(4). F(4) is the force of attraction of steel blocks to magnets in position 4 in FIG. 29. Accordingly F(1) is the force of attraction of steel blocks to magnets in position 1 in FIG. 29.

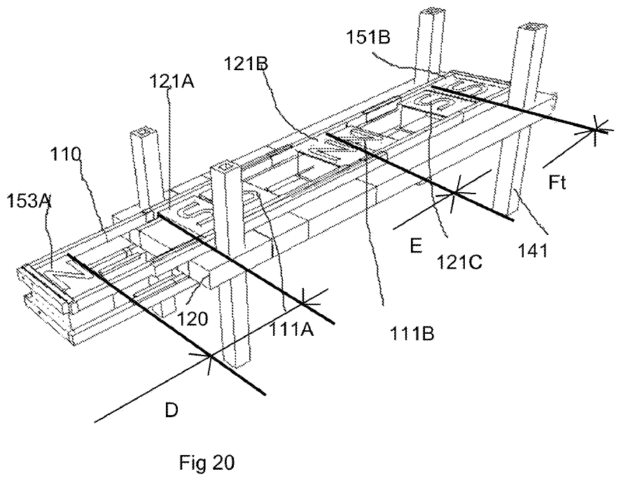

Further, under the influence of a complex of forces F the crank mechanism 230B shown in FIG. 25 clockwise rotate from top dead center to bottom dead center and cheeks 130 move. On the FIG. 25 the movement of the cheeks 130 continues until the teeth of the gear 202 move into the gap at the point of interaction with the gear 204B which corresponds to position 2 in FIG. 18 when M is in M0, K is in K2, I is in I1. Thus, there is a transition of M from M5 to M0, K from K1 to K2, which is shown in the diagram in FIG. 29 and in FIG. 25 where the crank mechanisms 230A are at bottom dead center, and the crank mechanism 230B are at top dead center.

Then the whole movement is repeated.

Let's look at the device in FIG. 18-20 in which two working magnets 111A, 111B with alternating poles are installed on the movable part of the carriage 110, while the auxiliary magnet 153B has a poles direction that matches the poles direction of the end magnet 121C, and also the compensating magnet 153A has a poles direction different from the poles direction of the counter magnet 121A.

Thus, looking at the moving part of the carriage 110, all the magnets installed on it come with alternating poles.

In this case, the power of the working magnet 111A should not be greater than the auxiliary magnet 153B. The power of working magnet 111B must be greater than the power of working magnet 111A.

Also installed on the stationary part of the carriage 120 are two end magnets 121B, 121C with alternating polarities, wherein the end magnet 121A has a poles direction opposite to the poles direction of the counter magnet 121A.

Thus, looking at the stationary part of the carriage 120, all the magnets installed on it come with alternating poles.

In this case, the power of each of the end magnets 121B, 121C should be less than the power of the counter magnet 121A.

Let's look at the device in FIG. 21 in which three working magnets 111A, 111B, 111C with alternating poles are installed on the movable part of the carriage 110. In this case, the auxiliary 153B has a poles direction that matches the poles direction of the end magnet 121C, and the compensating magnet 153A has a different polarity from the counter magnet 121A.

Thus, looking at the moving part of the carriage 110, all the magnets installed on it come with alternating poles. The power of the working magnet 111A should not be greater than the compensating magnet 153A and the auxiliary magnet 153B. The powers of all other working magnets 111B, 111C must be greater than the power of working magnet 111A. And also on the specified stationary part of the carriage 120, three end magnets 121B, 121C, 121D are installed with alternating polarity, while the specified end magnet 121B has a poles direction opposite to the direction of the poles of the counter magnet 121A.

Thus, looking at the stationary part of the carriage 120, all the magnets installed on it come with alternating poles. The power of each of the end magnets 121B, 121C, 121D must be less than the power of the counter magnet 121A.

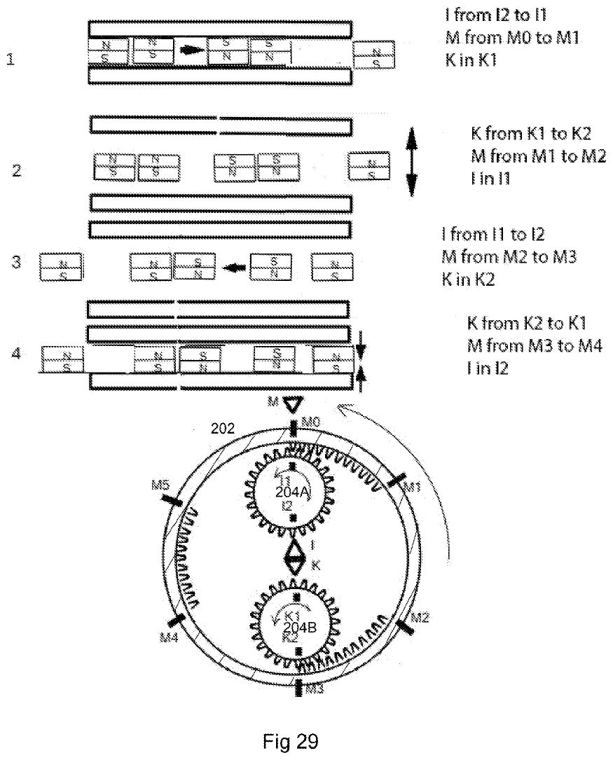

Let's look at the device 900 in FIG. 27, which uses a series connection of several traction mechanisms 100.

The compensating magnet 153A-2 from the movable part of the carriage of the second traction mechanism is attached to the auxiliary magnet 153B-1 of the movable part of the carriage 110 of the first traction mechanism 100.

The fasteners 133 is connected to the subsequent cheeks 130 and a gap L is formed between the steel blocks 132 in FIG. 7 with a width equal to the summary width of the magnets 153A-2 and 153B-1.

The two fasteners 133 of the upper cheeks are connected to the connecting rods 205, shown in FIG. 17, from the crankshafts 230B, 240 of the transmission mechanisms.

The two fasteners 133 of the lower cheeks are connected to the connecting rods 205, shown in FIG. 17, from the crankshafts 230B, 240 of the transmission mechanisms.

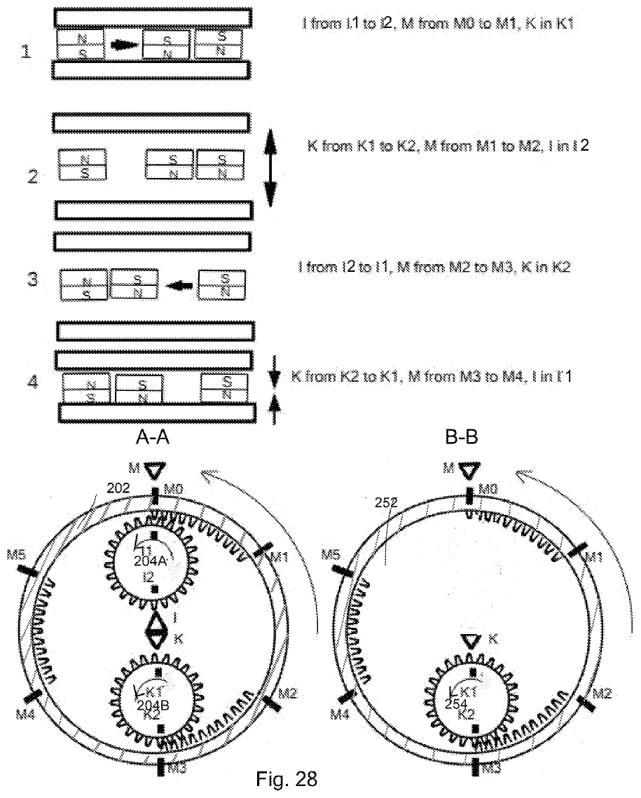

Consider device 800 in FIG. 26, which uses parallel connection of several traction mechanisms. The carriages are located one above the other on common racks 141. All upper cheeks 130 are attached to the lower ones using fasteners 135, which are bolted to fasteners 133. The compensating magnet 153B-2 from the movable part of the carriage of the second traction mechanism is attached to the compensating magnet 153B-1 of the movable part of the carriage of the first traction mechanism using fastening 136. The two fasteners 133 of the upper cheeks of the first traction mechanism are connected to the connecting rods 205, shown in FIG. 17, from the crankshafts of the transmission mechanism 230B, 240. The two fasteners 133 of the lower cheeks of the first traction mechanism are connected to the connecting rods 205, shown in FIG. 17, from the crankshafts of the transmission mechanism 230B, 240.

While embodiments of the invention may illustrate a particular orientation of a magnetic field, it is to be understood that the orientation is for explanation and not required orientation. That is, embodiments having the magnetic fields in other orientations are also possible.

### REFERENCE SIGNS LIST

121A—counter magnet
121B—end magnet
111A—working magnet
153A—compensating magnet
153B—auxiliary magnet
110—movable part of the carriage
120—stationary part of the carriage
132—steel block
160—spring
205—connecting rod
207—crankshaft
206—auxiliary shaft of the main transmission mechanism
256—auxiliary shaft of the auxiliary transmission mechanism
208—first main shaft
258—second main shaft
401—power take-off gear
202—first gear ring with partial teeth
252—second gear ring with partial teeth
204A—first planet gear
204B—second planet gear
254—third planetary gear
201—first gear ring with a full set of teeth
251—second gear ring with a full set of teeth
203—planetary gear of the main gearbox
253—planetary gear of the auxiliary gearbox
214—first sun gear
264—second sun gear
206, 256—axis
301—lever
302—rod
143—mounting on a stand
409—generator

1. A magnet motor, comprising:
a moving part of the carriage; and
a stationary part of the carriage, comprising:
a counter magnet, wherein the counter magnet installed with the direction of the poles perpendicular to the plane of movement of the said movable part of the carriage; and
a first end magnet, wherein the first end magnet installed with the poles direction perpendicular to the plane of movement of the said movable part of the carriage and opposite to the poles direction of the specified counter magnet; and
a first working magnet, wherein the first working magnet installed in the said moving part of the carriage with the direction of the poles perpendicular to the plane of movement of the said movable part of the carriage and coinciding with the direction of the poles of the specified counter magnet; and
a first steel block, wherein, in the state of the moving part of the carriage when the distance E changes from the minimum to the maximum and the first working magnet moves from the first end one repelling from it to the counter one being attracted to it, there should be the maximum possible gap between the first steel block and the first pole of the first working magnet, and wherein, in the state of the moving part of the carriage, when the distance E changes from maximum to minimum and the first working magnet moves from the counter magnet attracting to it to the first end magnet repelling from it, then the first steel block should approach the first pole of the first working magnet as close as possible; and
a second steel block, wherein, in the state of the moving part of the carriage when distance E changes from minimum to maximum and the first working magnet moves from the first end magnet repelling from it to the counter one being attracted to it, then there should be the maximum possible gap between the second steel block and the second pole of the first working magnet, and wherein, in the state of the moving part of the carriage, when the distance E changes from maximum to minimum and the first working magnet moves from the counter magnet attracting to it to the first end magnet repelling from it, then the second steel block should approach the second pole of the first working magnet as close as possible; and
a springs between the first steel block and the stationary part of the carriage; and
a springs between the second steel block and the stationary part of the carriage; and
a compensating magnet; and
an auxiliary magnet.

2. The magnet motor of claim 1, wherein the said compensating magnet is installed on the movable part of the carriage with the pole direction perpendicular to the plane of movement of the movable part of the carriage, and wherein the pole direction of said compensating magnet is opposite to the pole direction of the counter magnet, and wherein the distance D between the counter and compensating magnet must be maintained in the state of the moving part of the carriage when the distance E is maximum, and wherein said auxiliary magnet is installed on the movable part of the carriage with the pole direction perpendicular to the plane of movement of the movable part of the carriage, and wherein the pole direction of said auxiliary magnet coincides with the pole direction of the said first end magnet, and wherein the minimum possible distance between the final and auxiliary magnets must be maintained in the state of the moving part of the carriage when the distance E is minimal, and wherein the said first working magnet has less power compared to said compensating and auxiliary magnets, wherein the first end magnet has less power compared to the said counter magnet, and wherein when the distance E is maximum, the poles of compensating magnet must be completely closed by steel blocks, while the auxiliary magnet must be separated from the steel blocks by at least a distance A, and wherein when the distance E is minimum, the poles of auxiliary magnet must be completely closed by steel blocks, and at the same time, the compensating magnet must be spaced from steel blocks at least a distance of C.

3. The magnet motor of a claim 2, further comprising:
a first connecting rod connected to the first block; and
a second connecting rod connected to the first block; and
a third connecting rod connected to the second block; and
a fourth connecting rod connected to the second block; and
a fifth connecting rod connected to the said movable part of the carriage; and
a sixth connecting rod connected to the said movable part of the carriage.

4. The magnet motor of a claim 3, further comprising:
a first crankshaft connected to the first connecting rod; and
a second crankshaft connected to the third connecting rod; and
a third crankshaft connected to the second connecting rod; and
a fourth crankshaft connected to the fourth connecting rod; and
a fifth crankshaft connected to the fifth connecting rod; and
a sixth crankshaft connected to the sixth connecting rod.

5. The magnet motor of a claim 4, further comprising:
a first auxiliary shaft of the main transmission mechanism fixed on the first crankshaft and on the second crankshaft; and
a second auxiliary shaft of the main transmission mechanism fixed on the fifth crankshaft and on the sixth crankshaft; and
a first auxiliary shaft of the auxiliary transmission mechanism fixed on the third crankshaft and on the fourth crankshaft.

6. The magnet motor of a claim 5, further comprising:
a main transmission mechanism which comprising:
a first gear ring with partial set of teeth; and
a first planetary gear fixed on the first auxiliary shaft of the main transmission mechanism and interacting with the first gear ring with partial set of teeth; and
a second planetary gear fixed on the second auxiliary shaft of the main transmission mechanism and interacting with the first gear ring with partial set of teeth.

7. The magnet motor of a claim 6, further comprising:
an auxiliary transmission mechanism which comprising:
a second gear ring with partial set of teeth; and
a third planetary gear mounted on the first auxiliary shaft of the auxiliary transmission mechanism and interacting with the second gear with a ring with partial set of teeth.

8. The magnet motor of a claim 7, further comprising:
a first main shaft; and
a second main shaft; and
a power take-off gear mounted on the first main shaft; and
the main transmission mechanism which further comprising:
a first gear ring with a full set of teeth; and
a first axis; and
a second axis; and
a first planetary gear of the main gearbox installed on the first auxiliary shaft of the main transmission mechanism and rotates on the said auxiliary shaft of the main transmission mechanism; and
a second planetary gear of the main gearbox installed on the first axis and rotates on the said first axis; and
a third planetary gear of the main gearbox installed on the second axis and rotates freely on the specified second axis; and
a first sun gear fixed on the first main shaft and interacting with the first planetary gear of the main gearbox, with the second planetary gear of the main gearbox, with the third planetary gear of the main gearbox; and
the auxiliary transmission mechanism which further comprising:
a second ring gear with a full set of teeth; and
a third axis; and
a fourth axis; and
a first planetary gear of the auxiliary gearbox installed on the first auxiliary shaft of the auxiliary transmission mechanism and rotating on said first auxiliary shaft of the auxiliary transmission mechanism; and
a second planetary gear of the auxiliary gearbox installed on the third axis and rotates on said third axis; and
a second sun gear mounted on the fourth axis and rotating on said fourth axis; and
a third planetary gear of the auxiliary gearbox fixed on the second main shaft; and
a synchronizing mechanism which comprising:
a first lever fixed on the first main axis; and
a second lever mounted on the first main axis; and
a third lever fixed on the second main axis; and
a fourth lever fixed on the second main axis; and
a first rod connected on the first lever and on the second lever; and
a second rod connected on the third lever and on the fourth lever.

9. The magnet motor of a claim 8, further comprising a generator.

10. The magnet motor of a claim 3, further comprising:
a first crankshaft connected to the second connecting rod; and
a second crankshaft connected to the fourth connecting rod; and
a third crankshaft connected to the fifth connecting rod; and
a fourth crankshaft connected to the sixth connecting rod; and
wherein said first connecting rod is installed on the second block from the first end and the second end is bolted to the mounting on a stand, and wherein the said third connecting rod is installed on the second block from the first end and the second end is bolted to the mounting on a stand.

11. The magnet motor of a claim 10, further comprising:
a first auxiliary shaft of the main transmission mechanism fixed on the first crankshaft and on the second crankshaft; and
a second auxiliary shaft of the main transmission mechanism fixed on the third crankshaft and on the fourth crankshaft.

12. The magnet motor of a claim 11, further comprising:
the main transmission mechanism, further comprising:
a first ring gear with partial set of teeth; and
a first planetary gear fixed on the first auxiliary shaft of the main transmission mechanism and interacting with the first gear ring with partial set of teeth; and
a second planetary gear fixed on the second auxiliary shaft of the main transmission mechanism and interacting with the first gear ring with partial set of teeth.

13. The magnet motor of a claim 12, further comprising:
a first main shaft; and
a power take-off gear fixed on the first main shaft
the main transmission mechanism further comprising:
a first ring gear with a full set of teeth; and
a first axis; and
a second axis; and
a first planetary gear of the main gearbox installed on the first auxiliary shaft of the main transmission mechanism and rotates freely on the said auxiliary shaft of the main transmission mechanism; and
at least one second planetary gear of the main gearbox installed on the first axis and rotates freely on the specified first axis; and
a third planetary gear of the main gearbox installed on the second axis and rotates freely on the specified second axis; and
a first sun gear fixed on the first main shaft and interacting with the third planetary gear of the main gearbox, with the fourth planetary gear of the main gearbox, with the fifth planetary gear of the main gearbox; and
a generator.

14. A magnet motor comprising:
a first crankshaft; and
a second crankshaft; and
an auxiliary transmission mechanism which comprising:
a first auxiliary shaft of the said auxiliary transmission mechanism fixed on the first crankshaft and on the second crankshaft; and
a second gear ring with partial set of teeth; and
a third planetary gear mounted on the first auxiliary shaft of the auxiliary transmission mechanism and interacting with the first gear ring with partial set of teeth.

15. The magnet motor of a claim 14, further comprising:
a third crankshaft; and
a fourth crankshaft; and
a fifth crankshaft; and
a sixth crankshaft; and
a main transmission mechanism which comprising:
a first gear ring with partial set of teeth; and
a first auxiliary shaft of the main transmission mechanism fixed on the third crankshaft and on the fourth crankshaft; and
a second auxiliary shaft of the main transmission mechanism fixed on the fifth crankshaft and on the sixth crankshaft; and
a first planetary gear fixed on the first auxiliary shaft of the main transmission mechanism and interacting with the second gear ring with partial set of teeth; and
a second planetary gear fixed on the second auxiliary shaft of the main transmission mechanism and interacting with the second gear ring with partial set of teeth; and

16. The magnet motor of a claim 15, further comprising:
a stationary part of the carriage, comprising:
a counter magnet, wherein the counter magnet installed with the direction of the poles perpendicular to the plane of movement of the said movable part of the carriage; and
a first end magnet, wherein the first end magnet installed with the poles direction perpendicular to the plane of movement of the said movable part of the carriage and opposite to the poles direction of the specified counter magnet; and
a first working magnet, wherein the first working magnet installed in the said moving part of the carriage with the direction of the poles perpendicular to the plane of movement of the said movable part of the carriage and coinciding with the direction of the poles of the specified counter magnet; and
a first steel block, wherein, in the state of the moving part of the carriage when the distance E changes from the minimum to the maximum and the first working magnet moves from the first end one repelling from it to the counter one being attracted to it, there should be the maximum possible gap between the first steel block and the first pole of the first working magnet, and wherein, in the state of the moving part of the carriage, when the distance E changes from maximum to minimum and the first working magnet moves from the counter magnet attracting to it to the first end magnet repelling from it, then the first steel block should approach the first pole of the first working magnet as close as possible; and
a second steel block, wherein, in the state of the moving part of the carriage when distance E changes from minimum to maximum and the first working magnet moves from the first end magnet repelling from it to the counter one being attracted to it, then there should be the maximum possible gap between the second steel block and the second pole of the first working magnet and wherein in the state of the moving part of the carriage, when the distance E changes from maximum to minimum and the first working magnet moves from the counter magnet attracting to it to the first end magnet repelling from it, then the second steel block should approach the second pole of the first working magnet as close as possible; and
a springs between the first steel block and the stationary part of the carriage; and
a springs between the second steel block and the stationary part of the carriage; and
a compensating magnet; and
an auxiliary magnet

17. The magnet motor of a claim 16, further comprising:
a first connecting rod connected to the first block and to the first crankshaft; and
a second connecting rod connected to the second block and to the second crankshaft; and
a third connecting rod connected to the first block and to the third crankshaft; and
a fourth connecting rod connected to the second block and to the fourth crankshaft; and
a fifth connecting rod connected to the said movable part of the carriage and to the fifth crankshaft; and
a sixth connecting rod connected to the said movable part of the carriage and to the sixth crankshaft; and

18. (canceled)

19. The magnet motor of a claim 18, further comprising:
a first main shaft; and
a second main shaft; and
a power take-off gear mounted on the first main shaft; and
the main transmission mechanism which further comprising:
a first gear ring with a full set of teeth; and
a first axis; and
a second axis; and
a first planetary gear of the main gearbox-installed on the first auxiliary shaft of the main transmission mechanism and rotates on the said auxiliary shaft of the main transmission mechanism; and
a second planetary gear of the main gearbox installed on the first axis and rotates on the said first axis; and
a third planetary gear of the main gearbox installed on the second axis and rotates freely on the specified second axis; and
a first sun gear fixed on the first main shaft and interacting with the first planetary gear of the main gearbox, with the second planetary gear of the main gearbox, with the third planetary gear of the main gearbox; and
the auxiliary transmission mechanism which further comprising:
a second ring gear with a full set of teeth; and
a third axis; and
a fourth axis; and
a first planetary gear of the auxiliary gearbox installed on the first auxiliary shaft of the auxiliary transmission mechanism and rotating on said first auxiliary shaft of the auxiliary transmission mechanism; and
a second planetary gear of the auxiliary gearbox installed on the third axis and rotates on said third axis; and
a second sun gear mounted on the fourth axis and rotating on said fourth axis; and
a third planetary gear of the auxiliary gearbox fixed on the second main shaft; and
a synchronizing mechanism which comprising:
a first lever fixed on the first main axis; and
a second lever mounted on the first main axis; and
a third lever fixed on the second main axis; and
a fourth lever fixed on the second main axis; and
a first rod connected on the first lever and on the second lever; and
a second rod connected on the third lever and on the fourth lever; and
a generator.

20. A magnet motor comprising:
a moving part of the carriage; and
a stationary part of the carriage, comprising:
a counter magnet installed with the direction of the pole perpendicular to the plane of movement of the said movable part of the carriage; and
a plurality of end magnets of alternating polarity are installed on the said stationary part of the carriage with the poles direction perpendicular to the plane of movement of the said movable part of the carriage; and
a first steel block; and
a second steel block; and
a plurality of working magnets of alternating polarity are installed on the movable part of the carriage with the direction of the pole perpendicular to the plane of movement of the said movable part of the carriage; and
a compensating magnet is installed on the movable part of the carriage with the poles direction perpendicular to the plane of movement of the movable part of the carriage, and wherein the pole direction of said compensating magnet is opposite to the poles direction of the counter magnet; and
an auxiliary magnet is installed on the movable part of the carriage with the poles direction perpendicular to the plane of movement of the movable part of the carriage, and wherein the said auxiliary magnet with the direction of the pole coincides with the direction of the pole of the end magnet closest to it, wherein, the power of the working magnet closest to the compensating magnet should not be greater than the compensating magnet, and wherein the direction of the poles of the working magnet closest to the compensating magnet should coincide with the direction of the poles of the said counter magnet, and wherein the power of all other working magnets must be greater than the power of the working magnet closest to the compensating magnet, and wherein the said end magnet closest to the said counter magnet has the direction of the poles opposite to the direction of the poles of the said counter magnet, and wherein the force of each of the end magnets must be less than the force of the counter magnet, and wherein the distance D between the counter and compensating magnet must be maintained in the state of the moving part of the carriage when the distance E is maximum, and wherein the minimum possible distance must be maintained between the auxiliary magnet and the end magnet closest to it in the state of the moving part of the carriage when the distance E is minimum, and wherein when the distance E is maximum, the poles of compensating magnet must be completely closed by steel blocks, while the auxiliary magnet must be separated from the steel blocks by at least a distance A, and
wherein when the distance E is minimum, the poles of auxiliary magnet must be completely closed by steel blocks, and at the same time, the compensating magnet must be spaced from steel blocks at least a distance of C.
